(19) United States
(12) Patent Application Publication
(10) Pub. No.: US 2025/0330329 A1
(43) Pub. Date: Oct. 23, 2025

(54) COMPUTER SYSTEM AND DATA TRANSMISSION METHOD

(71) Applicant: Hitachi, Ltd., Tokyo (JP)

(72) Inventors: Ryoma KUBO, Tokyo (JP); Kagayaki ODA, Tokyo (JP); Yusuke OBI, Tokyo (JP)

(21) Appl. No.: 19/066,369

(22) Filed: Feb. 28, 2025

(30) Foreign Application Priority Data
Apr. 17, 2024 (JP) 2024-066676

(51) Int. Cl. H04L 9/32

(52) U.S. Cl. CPC H04L 9/3236

(57) ABSTRACT

A computer system, comprises a collection system configured to collect business data including values of a plurality of items from a plurality of business systems and a plurality of data processing systems. The collection system is coupled to an AI processing system configured to execute, through use of encrypted business data, training processing of generating a machine learning model. Each of the plurality of data processing systems obtains the business data from one of the plurality of business systems; encrypts a value of any one of the plurality of items of the business data through use of an irreversible encryption algorithm to generate the encrypted business data; and transmit the encrypted business data to the collection system. The collection system transmits the encrypted business data to the AI processing system.

### CLAIM OF PRIORITY

The present application claims priority from Japanese patent application JP 2024-066676 filed on Apr. 17, 2024, the content of which is hereby incorporated by reference into this application.

### BACKGROUND OF THE INVENTION

This invention relates to a technology for collecting data to be used to train a machine learning model.

In recent years, labor shortage has become a problem in various types of businesses, and use of AI in a business has been attracting attention. A large amount of training data is required to generate AI, that is, a machine learning model, which supports a business.

In a case where the amount of training data is small, reliability of an inference result obtained by the machine learning model is low. Thus, a worker is required to examine the inference result, to thereby correct the inference result. Consequently, the advantage of the use of the AI cannot be utilized.

As a technology for increasing the amount of training data, for example, a technology as described in WO 2021/176605 A1 has been known. In WO 2021/176605 A1, the following is disclosed: “An acquisition unit that acquires first image, second image, first correct answer information corresponding to the first image, and second correct answer information corresponding to the second image, a first neural network that generates a first feature map by inputting the first image, and generates a second feature map by inputting the second image, a feature map synthesis unit that generates a composite feature map by replacing a part of the first feature map with a part of the second feature map, a second neural network that generates output information on the basis of the composite feature map, an output error calculation unit that calculates an output error on the basis of the output information, the first correct answer information, and the second correct answer information, a neural network update unit that updates the first neural network and the second neural network on the basis of the output error, the learning data creation system includes the learning data creation system.” The method as described in WO 2021/176605 A1 is effective for a machine learning model which executes image recognition.

### SUMMARY OF THE INVENTION

As a method of increasing the amount of training data for the machine learning model which supports a business, it is conceivable to collect training data from users (companies) of the same business type. Even when the amount of training data which can be obtained from one user is small, a large amount of training data can be collected by collecting the training data from the users of the same business type.

However, business data to be provided as the training data includes confidential information, and hence directly providing the business data to the outside has a problem in terms of security.

A representative example of the present invention disclosed in this specification is as follows: a computer system comprises: a collection system configured to collect business data including values of a plurality of items from a plurality of business systems; and a plurality of data processing systems configured to process the business data. The collection system is coupled to an AI processing system configured to execute, through use of encrypted business data, at least one of training processing of generating a machine learning model or inference processing of executing inference through use of the machine learning model. Each of the plurality of data processing systems being configured to: obtain the business data from one of the plurality of business systems; encrypt a value of any one of the plurality of items of the business data through use of an irreversible encryption algorithm to generate the encrypted business data; and transmit the encrypted business data to the collection system. The collection system is configured to transmit the encrypted business data to the AI processing system.

According to this invention, it is possible to increase the number of pieces of data to be used to train a machine learning model while ensuring security of information. Problems, configurations, and effects other than those described above become apparent from the following description of at least one embodiment.

### BRIEF DESCRIPTION OF THE DRAWINGS

The present invention can be appreciated by the description which follows in conjunction with the following figures, wherein:

FIG. 1 is a diagram for illustrating an example of a configuration of a computer system according to a first embodiment of this invention;

FIG. 2 is a diagram for illustrating an example of a configuration of a data processing server in the first embodiment;

FIG. 3 is a sequence diagram for illustrating a flow of generation processing for format rule information in the computer system according to the first embodiment;

FIG. 4A, FIG. 4B, and FIG. 4C are views for illustrating an example of a user interface presented by the data processing server in the first embodiment;

FIG. 5 is a sequence diagram for illustrating a flow of transmission processing for business data in the computer system according to the first embodiment;

FIG. 6A, FIG. 6B, and FIG. 6C are tables for showing a specific example of processing of the data processing server in the first embodiment;

FIG. 7 is a sequence diagram for illustrating a flow of transmission processing for the business data in the computer system according to the first embodiment; and

FIG. 8A, FIG. 8B, and FIG. 8C are tables for showing a specific example of processing of the data processing server in the first embodiment.

### DETAILED DESCRIPTION OF THE PREFERRED EMBODIMENTS

Now, description is given of at least one embodiment of this invention referring to the drawings. It should be noted that this invention is not to be construed by limiting the invention to the content described in the following at least one embodiment. A person skilled in the art would easily recognize that specific configurations described in the following at least one embodiment may be changed within the scope of the concept and the gist of this invention.

In configurations of the at least one embodiment of this invention described below, the same or similar components or functions are denoted by the same reference numerals, and a redundant description thereof is omitted here.

Notations of, for example, “first”, “second”, and “third” herein are assigned to distinguish between components, and do not necessarily limit the number or order of those components.

### First Embodiment

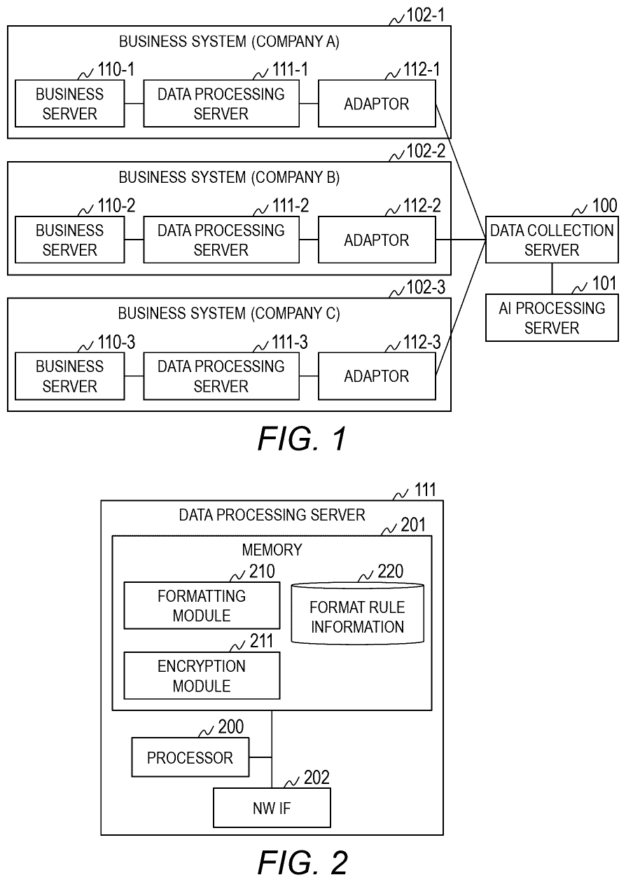

FIG. 1 is a diagram for illustrating an example of a configuration of a computer system according to a first embodiment of this invention.

The computer system is formed of a data collection server 100, an AI processing server 101, and a plurality of business systems 102. The data collection server 100 is coupled to the plurality of business systems 102 via a network such as a local area network (LAN). Moreover, the data collection server 100 is coupled to the AI processing server 101 directly or via a network.

Each of the business systems 102 includes a business server 110, a data processing server 111, and an adaptor 112. The business system 102 may be a system of the on-premises type or a system of the cloud type such as software as a service (SaaS).

The business server 110 executes various types of processing relating to a business. The data processing server 111 obtains business data including values of a plurality of items from the business server 110, and executes various types of processing on the business data. The adaptor 112 communicates to and from the data collection server 100. The adaptor 112 may execute analysis, processing, communication processing, and the like on the business data as required.

The data collection server 100 collects the business data from the business systems 102, and transmits the collected business data to the AI processing server 101. The AI processing server 101 executes training of a machine learning model, and executes inference through use of the machine learning model. As the machine learning model, for example, a machine learning model for supporting a business in a port which handles export and import of container cargo is conceivable.

The AI processing server 101 may have the functions of the data collection server 100. The data collection server 100 and the AI processing server 101 may be built on computer systems (for example, pieces of SaaS) independent of each other, or may be built on the same computer system.

FIG. 2 is a diagram for illustrating an example of a configuration of the data processing server 111 in the first embodiment.

The data processing server 111 includes a processor 200, a memory 201, and a network interface 202. The data processing server 111 may include a storage device such as a hard disk drive (HDD) and a solid state drive (SSD), an input device such as a keyboard, a mouse, and a touch panel, and an output device such as a display.

The processor 200 executes a program stored in the memory 201. The processor 200 executes processing in accordance with the program, to thereby operate as a function module (module) which implements a specific function. In the following description, in a case in which the processing is described while the function module is used as a subject, this case indicates that the processor 200 is executing a program which implements this function module.

The memory 201 stores the program executed by the processor 200 and information used by the program. Moreover, the memory 201 is used as a work area. In the first embodiment, the memory 201 stores a program which implements a formatting module 210 and an encryption module 211, and also stores format rule information 220.

The formatting module 210 executes formatting processing on the business data. In the formatting processing executed on the business data, the name of an item and the value of an item in the business data are converted based on the format rule information 220.

The encryption module 211 encrypts the business data. Specifically, the encryption module 211 uses a hash function to encrypt the business data. The same hash function is set for the data processing servers 111 of the business systems 102. As a result, the same value is encrypted to the same hash value, and hence integration and consolidation of the encrypted business data of the business systems 102 can be achieved.

Regarding the function modules of the data processing server 111, a plurality of function modules may be unified into one function module, and one function module may be divided into a plurality of function modules such that each function module obtained after the division has a relevant function.

The format rule information 220 stores format rule data for the name of the item and format rule data for the value of the item. The format rule data for the name of the item is formed of the name of the item before the conversion and the name of the item after the conversion. The format rule data for the value of the item is formed of the item name, a unit system, and a unit after the conversion.

The format rule information 220 may be set in advance, or may be generated based on user input. Description is now given of a method of generating the format rule information 220 based on the user input.

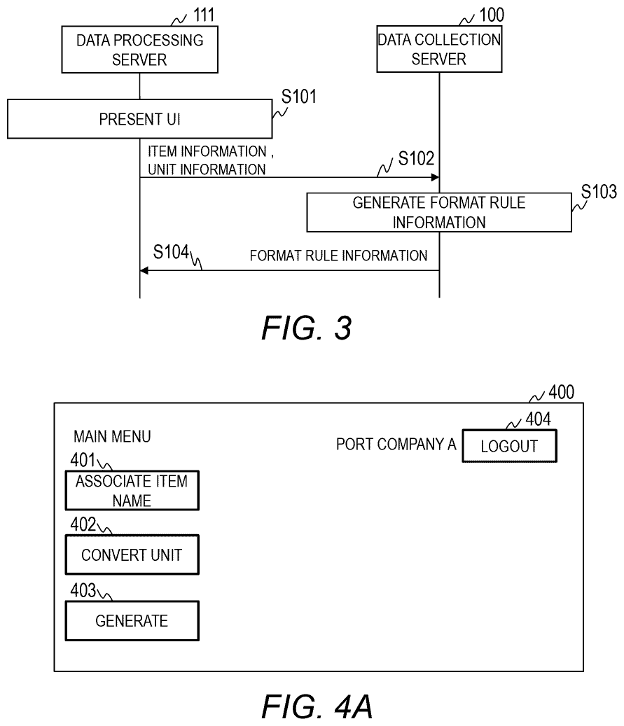

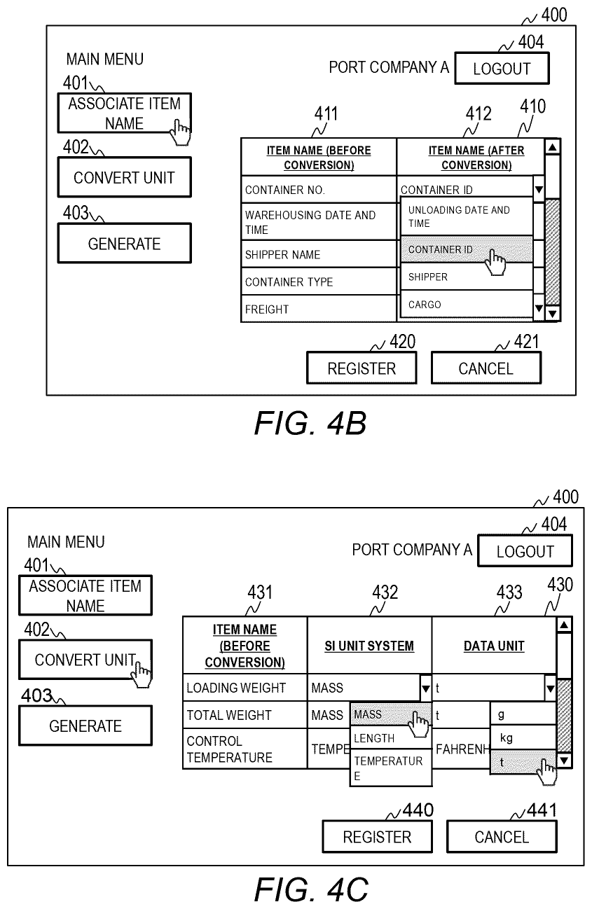

FIG. 3 is a sequence diagram for illustrating a flow of generation processing for the format rule information 220 in the computer system according to the first embodiment. FIG. 4A, FIG. 4B, and FIG. 4C are views for illustrating an example of a user interface presented by the data processing server 111 in the first embodiment.

The data processing server 111 presents a user interface 400 (S101).

The data processing server 111 first presents the user interface 400 illustrated in FIG. 4A. The user interface 400 includes buttons 401, 402, 403, and 404. The button 404 is an operation button for logging out.

When the button 401 is operated, the user interface 400 transitions to a state of FIG. 4B. On the user interface 400, a setting table 410 and buttons 420 and 421 are displayed. The setting table 410 displays entries each formed of an item name (before conversion) 411 and an item name (after conversion) 412. The setting table 410 has as many entries as the number of items included in the business data.

The item name (before conversion) 411 is a field for storing the name of the item of the business data. The item name (after conversion) 412 is a field for setting the name of the item after the conversion. In the item name (after conversion) 412, names of the item common in the computer system are displayed in, for example, a pulldown menu form.

After the user sets an appropriate name in the item name (after conversion) 412 of each item, the user operates the button 420 to set the setting table 410 as item information. After the button 420 is operated, the user interface 400 transitions to the state of FIG. 4A. When the button 421 is operated, the user interface 400 transitions to the state of FIG. 4A without the item information being set.

When the button 402 is operated, the user interface 400 transitions to a state of FIG. 4C. On the user interface 400, a setting table 430 and buttons 440 and 441 are displayed. The setting table 430 displays entries each formed of an item name (before conversion) 431, an SI unit system 432, and a data unit 433. The setting table 430 has as many entries as the number of items in which values having units are stored.

The item name (before conversion) 431 is a field for storing the name of the item in which the value having a unit is stored. The SI unit system 432 is a field for setting a type of the unit of the value of the item. In the SI unit system 432, names of the unit common in the computer system are displayed in, for example, a pulldown menu form. The data unit 433 is a field for setting the unit of the value stored in the item. In the data unit 433, the units of the value are displayed in, for example, a pulldown menu form.

After the user sets appropriate values in the SI unit system 432 and the data unit 433, the user operates the button 440 to set the setting table 430 as unit information. After the button 440 is operated, the user interface 400 transitions to the state of FIG. 4A. When the button 441 is operated, the user interface 400 transitions to the state of FIG. 4A without the unit information being set.

When the button 403 is operated, the data processing server 111 transmits the item information and the unit information to the data collection server 100 (S102). Only any one of the item information or the unit information may be transmitted to the data collection server 100.

When the data collection server 100 receives the item information and the unit information, the data collection server 100 generates the format rule information 220 (S103). Specifically, the following processing is executed.

(S103-1) The data collection server 100 generates each entry of the item information as format rule data for the name of the item.

(S103-2) The data collection server 100 associates, for each entry of the unit information, the item name and the unit with the unit common in the computer system, to thereby generate the format rule data for the value of the item.

The data collection server 100 transmits the format rule information 220 to the data processing server 111 (S104).

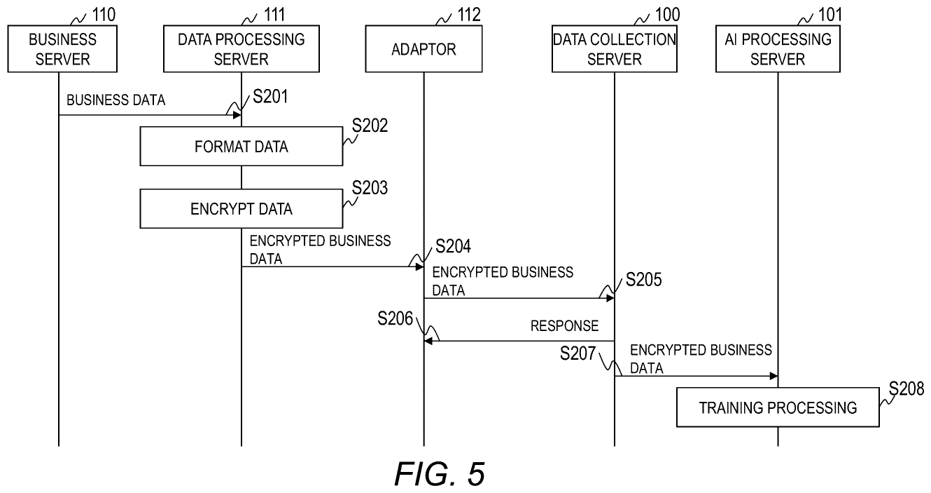

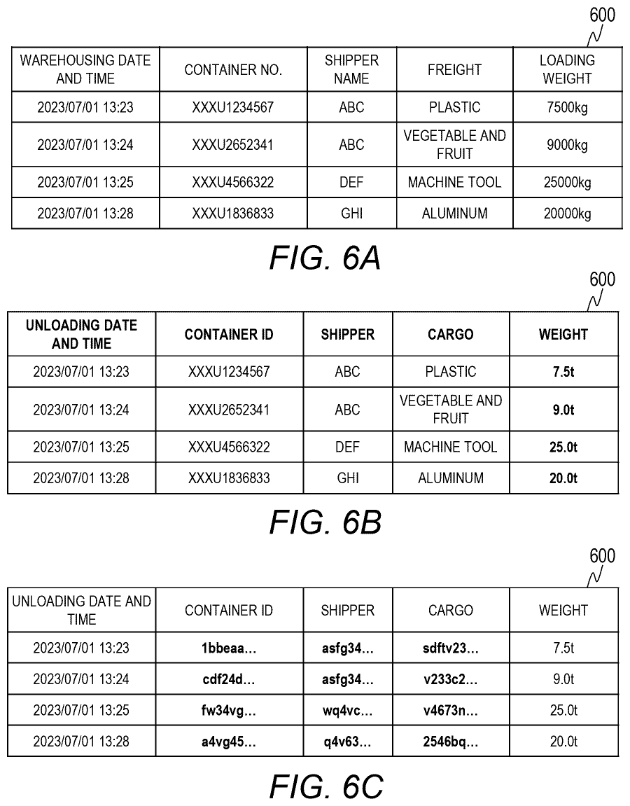

FIG. 5 is a sequence diagram for illustrating a flow of transmission processing for the business data in the computer system according to the first embodiment. FIG. 6A, FIG. 6B, and FIG. 6C are tables for showing a specific example of processing of the data processing server 111 in the first embodiment. With reference to FIG. 5, the transmission processing for business data to be used as training data is described.

The business server 110 transmits the business data for training to the data processing server 111 (S201). The data processing server 111 may obtain the business data from the business server 110.

The data processing server 111 executes formatting processing on the received business data based on the format rule information 220 (S202).

Specifically, the formatting module 210 converts the name of the item of the business data based on the format rule data for the name of the item. Moreover, the formatting module 210 converts the value of the item to a value in a specified unit based on the format rule data for the value of the item.

For example, when a table 600 including a plurality of pieces of business data as shown in FIG. 6A is received, the formatting module 210 converts the names of the items and the values of the items as shown in FIG. 6B. In FIG. 6B, “warehousing date and time” is converted to “ship unloading date and time,” “container No.” is converted to “container ID,” “shipper name” is converted to “shipper,” “freight” is converted to “cargo,” and “loading weight” is converted to “weight.” Moreover, the unit of the value of “loading weight” is converted from “kg” to “t”.

The data processing server 111 executes encryption processing on the business data on which the formatting processing has been executed (S203).

Specifically, the encryption module 211 inputs the value of a predetermined item to the hash function, to thereby calculate the hash value of the value of this item. For example, as shown in FIG. 6C, the values of “container ID,” “shipper,” and “cargo” are encrypted.

It is assumed that the items to be encrypted are set in advance. Even when a value indicating a type such as a product type and a gender is encrypted, a difference in type can be distinguished. Thus, in the first embodiment, the items to be encrypted are set based on the standpoints of the influence of loss of the information required for the inference by the machine learning model and ensuring of security.

The data processing server 111 transmits the business data after the encryption (encrypted business data) to the data collection server 100 via the adaptor 112 (S204 and S205).

The data collection server 100 transmits a reception response to the adaptor 112 in a case where the data collection server 100 has received the encrypted business data as the training data (S206), and transmits the encrypted business data to the AI processing server 101 (S207).

The AI processing server 101 uses, as the training data, the received encrypted business data to execute training processing (S208). The training processing is executed at any timing. It is possible to increase the number of samples of the training data by obtaining the encrypted business data from the plurality of business systems 102. Meanwhile, the encrypted business data has been subjected to the formatting processing, and hence can uniformly be treated. Moreover, the values of the items required to be concealed of the encrypted business data have been encrypted, and hence the security can be ensured.

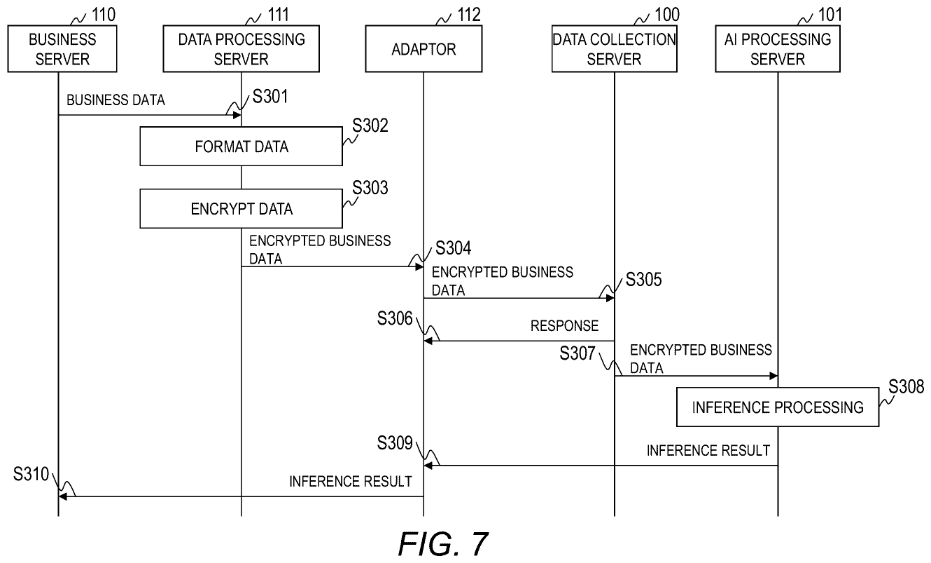

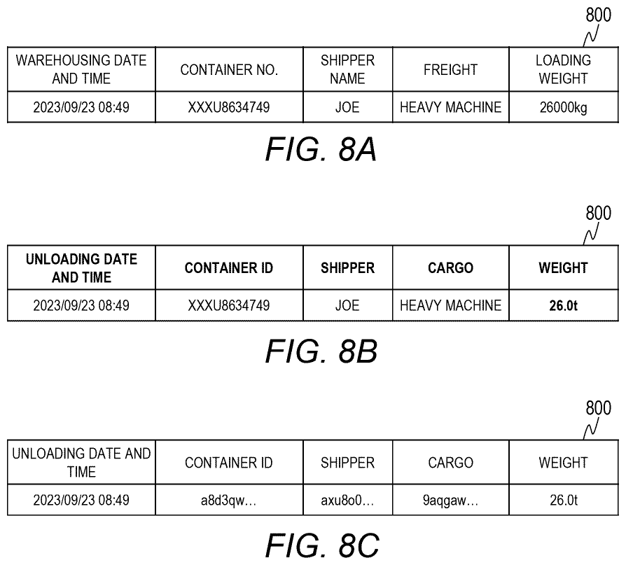

FIG. 7 is a sequence diagram for illustrating a flow of transmission processing for the business data in the computer system according to the first embodiment. FIG. 8A, FIG. 8B, and FIG. 8C are tables for showing a specific example of processing of the data processing server 111 in the first embodiment. With reference to FIG. 7, the transmission processing for business data to be used as data for inference is described.

The business server 110 transmits the business data for inference to the data processing server 111 (S301). The data processing server 111 may obtain the business data from the business server 110.

The data processing server 111 executes the formatting processing on the received business data based on the format rule information 220 (S302). The processing step of S302 is the same as that of S202.

For example, when business data 800 as shown in FIG. 8A is received, the formatting module 210 converts the names of the items and the values of the items as shown in FIG. 8B. In FIG. 8B, “warehousing date and time” is converted to “ship unloading date and time,” “container No.” is converted to “container ID,” “shipper name” is converted to “shipper,” “freight” is converted to “cargo,” and “loading weight” is converted to “weight.” Moreover, the unit of the value of “loading weight” is converted from “kg” to “t”.

The data processing server 111 executes the encryption processing on the business data on which the formatting processing has been executed (S303). The processing step of S303 is the same as that of S203.

For example, as shown in FIG. 8C, the values of “container ID,” “shipper,” and “cargo” are encrypted.

The data processing server 111 transmits the business data after the encryption (encrypted business data) to the data collection server 100 via the adaptor 112 (S304 and S305).

The data collection server 100 transmits a reception response to the adaptor 112 in a case where the data collection server 100 has received the encrypted business data as the data for inference (S306), and transmits the encrypted business data to the AI processing server 101 (S307).

The AI processing server 101 inputs the encrypted business data received as the data for inference to the machine learning model, to thereby execute inference processing (S308). The encrypted business data has been subjected to the formatting processing, and hence can uniformly be treated. Moreover, the values of the items required to be concealed of the encrypted business data have been encrypted, and hence the security can be ensured.

The AI processing server 101 transmits a result of the inference processing to the business server 110 via the adaptor 112 (S309 and S310).

The data processing server 111 is described as the configuration independent of the business server 110 and the adaptor 112, but the configuration is not limited to this example. For example, the business server 110 or the adaptor 112 may have the function of the data processing server 111.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, comprising:
a collection system configured to collect business data including values of a plurality of items from a plurality of business systems; and
a plurality of data processing systems configured to process the business data,
the collection system being coupled to an AI processing system configured to execute, through use of encrypted business data, at least one of training processing of generating a machine learning model or inference processing of executing inference through use of the machine learning model,
each of the plurality of data processing systems being configured to:
obtain the business data from one of the plurality of business systems;
encrypt a value of any one of the plurality of items of the business data through use of an irreversible encryption algorithm to generate the encrypted business data; and
transmit the encrypted business data to the collection system, and
wherein the collection system is configured to transmit the encrypted business data to the AI processing system.

2. The computer system according to claim 1,
wherein the each of the plurality of data processing systems is configured to encrypt the value of the any one of the plurality of items of the business data through use of a hash function, and
wherein the hash functions used by the plurality of data processing systems are the same.

3. The computer system according to claim 2, wherein the each of the plurality of data processing systems is configured to:
execute formatting processing of executing processing of converting a name of at least one of the plurality of items to a name of an item common among the plurality of business systems, and processing of converting a value of at least one of the plurality of items to a value in a unit common among the plurality of business systems; and
encrypt the value of the any one of the plurality of items of the business data on which the formatting processing has been executed.

4. The computer system according to claim 3,
wherein the each of the plurality of data processing systems is configured to obtain setting information relating to the name of the at least one of the plurality of items being a target of the formatting processing and the value of the at least one of the plurality of items being the target of the formatting processing, and transmit the setting information to the collection system,
wherein the collection system is configured to:
determine, based on the setting information, a format rule for the name of the at least one of the plurality of items being the target of the formatting processing and a format rule for the value of the at least one of the plurality of items being the target of the formatting processing, to thereby generate format rule information; and
transmit the format rule information to the each of the plurality of data processing systems, and
wherein the each of the plurality of data processing systems is configured to execute the formatting processing based on the format rule information.

5. A data transmission method to be executed by a computer system,
the computer system including a collection system configured to collect business data including values of a plurality of items from a plurality of business systems, and a plurality of data processing systems configured to process the business data,
the collection system being coupled to an AI processing system configured to execute, through use of encrypted business data, at least one of training processing of generating a machine learning model or inference processing of executing inference through use of the machine learning model,
the data transmission method comprising:
a first step of obtaining, by each of the plurality of data processing systems, the business data from one of the plurality of business systems;
a second step of encrypting, by the each of the plurality of data processing systems, a value of any one of the plurality of items of the business data through use of an irreversible encryption algorithm to generate the encrypted business data;
a third step of transmitting, by the each of the plurality of data processing systems, the encrypted business data to the collection system; and
a fourth step of transmitting, by the collection system, the encrypted business data to the AI processing system.

6. The data transmission method according to claim 5,
wherein the second step includes encrypting, by the each of the plurality of data processing systems, the value of the any one of the plurality of items of the business data through use of a hash function, and
wherein the hash functions used by the plurality of data processing systems are the same.

7. The data transmission method according to claim 6, wherein the second step includes:
a fifth step of executing, by the each of the plurality of data processing systems, formatting processing of executing processing of converting a name of at least one of the plurality of items to a name of an item common among the plurality of business systems, and processing of converting a value of at least one of the plurality of items to a value in a unit common among the plurality of business systems; and
a sixth step of encrypting, by the each of the plurality of data processing systems, the value of the any one of the plurality of items of the business data on which the formatting processing has been executed.

8. The data transmission method according to claim 7, further comprising:
obtaining, by the each of the plurality of data processing systems, setting information relating to the name of the at least one of the plurality of items being a target of the formatting processing and the value of the at least one of plurality of items being the target of the formatting processing, and transmitting the setting information to the collection system;
determining, by the collection system, based on the setting information, a format rule for the name of the at least one of the plurality of items being the target of the formatting processing and a format rule for the value of the at least one of the plurality of items being the target of the formatting processing, to thereby generate format rule information; and
transmitting, by the collection system, the format rule information to the each of the plurality of data processing systems,
wherein the fifth step includes executing, by the each of the plurality of data processing systems, the formatting processing based on the format rule information.
